(19) United States
(12) Patent Application Publication
(10) Pub. No.: US 2011/0143308 A1
(43) Pub. Date: Jun. 16, 2011

(54) PIEZO INSERT FOR IMPLANT SURGICAL OPERATION

(75) Inventor: Hong-Chan Lee, Seoul (KR)

(73) Assignee: GANGNAM CHICAGO DENTAL CLINIC , 7F, SEOUL (KR)

(21) Appl. No.: 13/057,311

(22) PCT Filed: Jul. 24, 2009
(86) PCT No.: PCT/KR09/04142

§ 371 Date: Feb. 3, 2011

(30) Foreign Application Priority Data
Aug. 21, 2008 (KR) 10-2008-0082066

(51) Int. Cl. A61C 3/00

(52) U.S. Cl. 433/80

(57) ABSTRACT

This disclosure provides a piezo insert for implant surgical operation comprising an insert pole having a water supply passage formed therein for supplying water to lift up a maxillary sinus membrane; and an insert tip comprising a plurality of water squirt holes provided along a circumferential direction of the insert pole at one end thereof, and a plurality of connecting passages for connecting the plurality of water squirt holes and the water supply passage.

### FIELD

This disclosure generally relates to a piezo insert for implant surgical operation, and more specifically to a piezo insert for implant surgical operation that can solve various problems such as a case of puncturing a maxillary sinus membrane, a case where the maxillary sinus membrane adheres to a floor underneath a maxillary sinus too tightly to separate, and a case where the membrane is punctured by vertical upward force, which exceeds the tension of the membrane, exerted on a septum that exists anatomically inside the maxillary sinus, that makes it easy to form a vertical hole or to expand the hole in the residual ridge of the maxillary sinus, thereby facilitating the filling of a bone graft material therein later, that further increases the rate of success of resulting implant surgical operation as compared with prior art, that prevents unintentional excessive force on the maxillary sinus membrane by limiting an excessive insertion depth of an insert tip that cuts toward and is inserted into an alveolar bone by disposing a stopper, and that secures completely safe surgical operation using stoppers of various lengths.

### BACKGROUND

Though an implant generally refers to a medical device manufactured to replace or make up for a missing biological structure, the implant in dentistry represents a kind of surgical operation for planting an artificial tooth.

The implant surgical operation is a procedure to restore the function of a tooth by planting a fixture, which is a tooth root made of titanium or the like that is not rejected by the human body, into the alveolar bone where a tooth is missing and by fixing the artificial tooth firmly so as to replace the missing tooth root.

Though a usual prosthetic device or a denture may decay the surrounding teeth and bones over time, a dental implant does not do any harm to surrounding tooth structures. In addition, a dental implant has almost the same functions and shape as those of a natural tooth, and is not susceptible to the formation of cavities, thereby making it possible to use semi-permanently.

The implant surgical operation (also referred to as “implant” or “dental implant procedure”) is carried out by first, boring a hole in an alveolar bone for an implant placement using a predetermined drill, then by placing a fixture in the hole of the alveolar bone and allowing osteointegration between the fixture and the bone, followed by fitting an abutment into the fixture and covering the abutment with a final prosthetic device.

Such implant surgical operation has become an important part in dentistry, and concepts and technologies associated with the implant surgical operation have been developing continuously.

The implant surgical operation has become so common that an easy case of the implant surgical operation can be carried out without any difficulties even by a dentist who does not have much experience.

However, there are still some issues to be addressed, one of them being represented by the implant surgical operation associated with a maxillary sinus.

Because of an insufficient residual ridge in a vertical direction in implant surgical operation of a maxillary posterior tooth, grafting is required in the maxillary sinus in many cases. Grafting in a maxillary sinus is now one of the common procedures in dentistry and is categorized into two types.

One of them is grafting with an osteotome, and the other is to form a lateral window on the lower part of a cheekbone and then to directly lift up a maxillary sinus membrane so as to pack a graft material between the interior border of the maxillary sinus and the maxillary sinus membrane.

However, if the height of a residual ridge is too low in the implant surgical operation, practically there is no other way but to use much wider flap design and to apply operation through lateral access.

When forming a window, however, it is very difficult to access the maxillary sinus because of possible rupture of blood vessels, of presence of a septum, and of very technique-sensitive procedure of lifting the sinus membrane. In addition, there also exists increased opportunistic infections because of a wide surgical area, and a patient may feel very uncomfortable during and after the surgical operation. The formation of a window itself involves intentionally removing a lateral part of a maxillary bone which in turn blocks blood flow of the area, so that a useful nutritional base indispensable for the process of self-ossification of a grafted bone becomes reduced, thereby causing an increased healing period and ossification time. Many pioneers have attempted to overcome the disadvantages and problems discussed above in many ways.

As one of such examples, Bucci Sabattini reported that, when maxillary sinus grafting was required for implant placement in a maxillary posterior tooth, it was possible to relax the maxillary sinus membrane and to fill the maxillary sinus with a grafting material by injecting an injectable graft material in the maxillary sinus (Bucci Sabattini, Salvatorelli. New simplified technique for major augmentation of the maxillary sinus, 35th Annual Meeting of the Continental European Division of the International Association for Dental Research, 1999). This is an exemplary type using hydraulic pressure.

Leon Chen reported that maxillary sinus grafting was carried out while the maxillary sinus membrane was exposed after grinding away the maxillary interior border of the maxillary sinus with a high-speed hand piece in fixation of 1557 implants in about 1100 cases that resulted in a very high rate of success in his research paper (Leon Chen, Jennifer Cha. An 8-Year Retrospective Study: 1100 Patients Receiving 1557 Implants Using the Minimally Invasive Hydraulic Sinus Condensing Technique. J. Periodontal 2005; 76:482-491). Chen named this surgical operation Hydraulic Sinus Condensing. This operation is a method of approaching an alveolar ridge as in the osteotome technique, but is considered as a totally new attempt.

However, some clinical dentists pointed out disadvantages in the method of Leon Chen, and expressed different views. The biggest drawback is that it is an extremely sensitive process and it is almost impossible to avoid contamination by cooling water that is essential for a high-speed hand piece. In particular, there is a possibility that the contamination of a graft material may be carried by the grafted bone in the maxillary sinus and could cause a delayed infection after the operation. In some cases, emphysema may be caused and it may be hard to prevent bone heating depending on the position of a water squirt hole in the hand piece head when the residual ridge is longer than 6 to 7 mm.

In late 1990s, Torrella used an ultrasonic device for a lateral approach in maxillary sinus operation and reported that such a method is clinically more convenient, as compared with prior art methods (Torrella F, Pitarch J, Cabanes G, Anita E. Ultrasonic osteotomy for the surgical approach of the maxillary sinus: A technical note, Int. J. Oral Maxillofac Implants 1998; 13; 697-700).

Vercellotti used a more improved piezoelectric device in maxillary bone grafting, to show that the procedure was clinically more convenient and easier to apply as compared with the prior art rotary device (Vercellotti T, De Paoli S, Nevins M., The piezoelectric bony window osteotomy and sinus floor elevation: Introduction of a new technique for simplification of the sinus augmentation procedure, Int. J. Periodontics Restorative Dent. 2001; 21: 561-567).

In 2003, a Korean professor Dong Seok Sohn received attention through an introduction of a case of bone grafting in a maxillary sinus with a piezoelectric device in Korea (Dental Clinic, 2002). Sohn reported in the Dental Clinic Journal that the piezoelectric device was advantageous in protecting a sensitive maxillary sinus membrane in forming a window and then lifting up the membrane because there is very low possibility of puncturing or bursting the maxillary sinus membrane even when the piezoelectric device touches soft tissues, namely the maxillary sinus membrane.

In the journal, Sohn obtained quite satisfactory results to both operators and patients as compared with the results of prior art, by attempting a technique of approaching the membrane from the position for implant placement, unlike prior art methods, while performing maxillary bone grafting in the maxillary sinus with the piezoelectric device.

It has been reported that, in performing implant surgical operation, the OSC technique which is a crestal approach using a piezoelectric device, namely using a piezo tip of a piezo insert for implant surgical operation shows very excellent results, as compared with the conventional sinus grafting procedure.

In other words, patients do not experience swelling after surgery because of the minimized surgical operation area, which eventually leads to reduced pain in the area. Furthermore, it is convenient for dentists to operate because the procedure is not a window technique to form a lateral window by cutting the lower part of a cheekbone, and there is much less opportunistic infection because of the reduced surgery area. Moreover, since the rate of success of the implant surgical operation has increased, it is considered that the procedure is a very useful technique.

Even with this procedure, however, there have been reported some problems such as a case where a maxillary sinus membrane is punctured by inadvertent force on the membrane when excessive force is exerted in order to cut out the bone near the maxillary sinus membrane or when a residual ridge is incorrectly measured or there exists an error different from the numerical value seen on radiology in the process of cutting into the residual ridge in order to reach the maxillary sinus membrane, a case where the maxillary sinus membrane adheres to a floor underneath the maxillary sinus too tightly to separate even after all the bones near the maxillary sinus have been cut out while maintaining the safety of the maxillary sinus membrane, and a case where the maxillary sinus membrane is punctured by vertical upward force, which exceeds the tension of the membrane, exerted on a septum that exists anatomically inside the maxillary sinus.

Though such problems described as above may be the procedural problems during the surgical operation, it is considered that the majority of the problems are attributed to the structural limitation of a piezo insert for implant surgical operation.

For instance, the piezo tip of a conventional piezo insert for implant surgical operation that is designed to squirt water from an end thereof spouts a strong stream of water from the upward end of the piezo tip only, thereby pushing a maxillary sinus membrane upward only. Accordingly, there may be a problem of puncturing the membrane by the strong upward force when the maxillary sinus membrane adheres to the interior border of the maxillary sinus too tightly to separate or when the membrane is too thin.

As such, since the maxillary sinus membrane may be punctured by the pressure of the water squirted only upward when the membrane is too thin or adheres to the interior border of the maxillary sinus too tightly, it is considered that the tension of the membrane can be considerably reduced if the side of the membrane, or the part below the maxillary sinus instead of the upper part of the membrane to be lifted up is separated first. In this way, it is expected that the membrane can be easily lifted up while preventing a puncture therein because the adhesiveness of the membrane on a side wall of the maxillary sinus is relatively weak.

Thus, in order for the maxillary sinus membrane to easily separate, it is more advantageous to squirt (spout) water laterally near the maxillary sinus instead of increasing the force on the membrane by squirting water only in an upward direction as in the conventional piezo insert. Furthermore, it is advantageous to squirt water at various angles including a horizontal direction when it comes to a lateral direction.

In this case, the water squirted in an upward direction should be used only as auxiliary means, and it is more advantageous to squirt water at various angles if possible, when it comes to an upward direction of water squirt.

Therefore, the applicant of this disclosure proposes a piezo insert for implant surgical operation that can solve various problems such as a case of puncturing a maxillary sinus membrane, a case where the maxillary sinus membrane adheres to a floor underneath a maxillary sinus too tightly to separate, and a case where the membrane is punctured by vertical upward force, which exceeds the tension of the membrane, exerted on a septum that exists anatomically inside the maxillary sinus, that makes it easy to form a vertical hole or to expand the hole in the residual ridge of the maxillary sinus, thereby facilitating the filling of a bone graft material therein later, and that further increases the rate of success of resulting implant surgical operation as compared with prior art.

### SUMMARY

### Object

The present disclosure provides a piezo insert for implant surgical operation that can solve various problems such as a case of puncturing a maxillary sinus membrane, a case where the maxillary sinus membrane adheres to a floor underneath a maxillary sinus too tightly to separate, and a case where the membrane is punctured by vertical upward force, which exceeds the tension of the membrane, exerted on a septum that exists anatomically inside the maxillary sinus, that makes it easy to form a vertical hole or to expand the hole in the residual ridge of the maxillary sinus, thereby facilitating the filling of a bone graft material therein later, and that further increases the rate of success of resulting implant surgical operation as compared with prior art.

In addition, the present disclosure provides a piezo insert for implant surgical operation that secures completely safe surgical operation by preventing unintentional excessive force on a maxillary sinus membrane by limiting an excessive insertion depth of an insert tip that cuts toward and is inserted into an alveolar bone.

### SOLUTION

The above object is achieved by a piezo insert for implant surgical operation comprising: an insert pole having a water supply passage formed therein for supplying water to lift up a maxillary sinus membrane; and an insert tip having a plurality of water squirt holes provided along a circumferential direction of the insert pole at one end thereof, and a plurality of connecting passages for connecting the plurality of water squirt holes and the water supply passage.

Here, the insert tip has an outer face that forms a cut face for cutting a bone, and may have an elliptical shape or a spherical shape that a part of the insert tip connected to the insert pole is partially cut out.

The plurality of water squirt holes may comprise a plurality of lateral water squirt holes formed along a circumferential direction of a middle part or a lower part of the insert tip for squirting water laterally, and at least one upward water squirt hole formed along a circumferential direction of an upper part of the insert tip for squirting water upward.

The at least one upward water squirt hole may be a plurality of upward water squirt holes, and the plurality of lateral water squirt holes and the plurality of upward water squirt holes may have a regular arrangement with respect to each along a circumferential direction of the insert tip.

A virtual water squirt angle connecting one of the lateral water squirt holes and one of the upward water squirt holes may be less than or equal to 90°.

The plurality of connecting passages may comprise a plurality of lateral connecting passages for interconnecting the plurality of lateral water squirt holes and the water supply passage, and a plurality of upward connecting passages for interconnecting the plurality of upward water squirt holes and the water supply passage, and each water flow space of the lateral connecting passages may be substantially equal to each water flow space of the upward connecting passages, or the water flow space of the lateral connecting passages may be formed larger than the water flow space of the upward connecting passages.

The lateral connecting passages may be formed such that a cross-sectional area thereof is gradually getting smaller or is gradually getting larger from the water supply passage side toward the lateral water squirt holes side.

End parts of the plurality of connecting passages that abut on the water supply passage are provided in one of the states where the end parts may be parallel to, be inclined with respect to, or intersect the water supply passage.

Inlet ends of the plurality of upward connecting passages are disposed at a location higher than the location of inlet ends of the plurality of lateral connecting passages at a non-horizontal position.

The piezo insert may further comprise an insert body for a handle connected to the insert pole.

The piezo insert may further comprise a stopper provided on the insert pole, for limiting an excessive insertion depth of the insert tip that cuts toward and is inserted into an alveolar bone.

The insert pole may comprise a working part having the insert tip formed at an end thereof, and a holding part, and the stopper is provided on an end of the holding part such that the stopper is longer than the rest of the holding part in a radial direction.

The working part and the holding part of the insert pole are attachable to and detachable from each other.

An attachment method between the working part and the holding part of the insert pole may be one of the methods selected from a screw connection method, a hook combination method or a press fit method.

The working part and the holding part of the insert pole may be integrally formed.

In addition, the present disclosure comprises an insert pole, and a stopper provided on the insert pole, for limiting an excessive insertion depth of the insert tip that cuts toward and is inserted into an alveolar bone.

### EFFECT

The present disclosure has an effect of solving various problems such as a case of puncturing a maxillary sinus membrane, a case where the maxillary sinus membrane adheres to a floor underneath a maxillary sinus too tightly to separate, and a case where the membrane is punctured by vertical upward force, which exceeds the tension of the membrane, exerted on a septum that exists anatomically inside the maxillary sinus, of making it easy to form a vertical hole or to expand the hole in the residual ridge of the maxillary sinus, thereby facilitating the filling of a bone graft material therein later, and of further increasing the rate of success of resulting implant surgical operation as compared with prior art.

In addition, the present disclosure has an effect of preventing unintentional excessive force on a maxillary sinus membrane by limiting an excessive insertion depth of an insert tip that cuts toward and is inserted into an alveolar bone by providing a stopper on an insert pole, and of securing completely safe surgical operation using stoppers of various lengths.

### DRAWINGS

FIG. 1 shows a region where the fixture of an implant will be placed and illustrates a case where sinus grafting is required because the residual ridge of an alveolar bone is too small;

FIG. 2 shows a state when a filling space for bone grafting is formed by lifting up a maxillary sinus membrane using a piezo insert for implant surgical operation in accordance with a first embodiment of the disclosure in FIG. 1;

FIG. 3 is a perspective view of the piezo insert for implant surgical operation in accordance with the first embodiment of the disclosure shown in FIG. 2;

FIG. 4 is a plan view of FIG. 3;

FIG. 5 is a schematic sectional view of a part of an insert tip of FIG. 3;

FIG. 6 is a perspective view of a piezo insert for implant surgical operation in accordance with a second embodiment of the disclosure;

FIG. 7 is an exploded perspective view of FIG. 6.

### BRIEF DESCRIPTIONS OF REFERENCE NUMBERS

1: region for placing the fixture of an implant,
2: alveolar bone
3: maxillary sinus,
4: maxillary sinus membrane
5: filling space for bone grafting,
10: piezo insert for implant surgical operation
20: insert pole,
30: insert tip
31, 32: water squirt holes,
33, 34: connecting passages
30: insert tip,
40: insert body
50: stopper

### DETAILED DESCRIPTION

Hereinafter, preferred embodiments of the disclosure will be described in detail with reference to the accompanying drawings. Like reference numerals are used to denote like elements throughout the description of the embodiments.

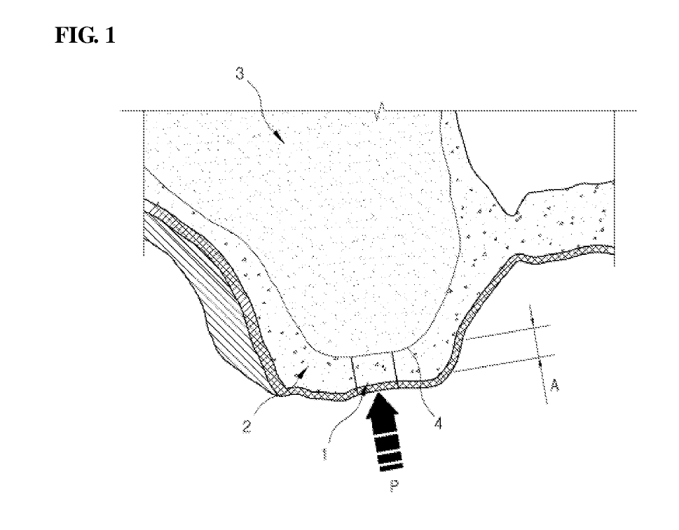

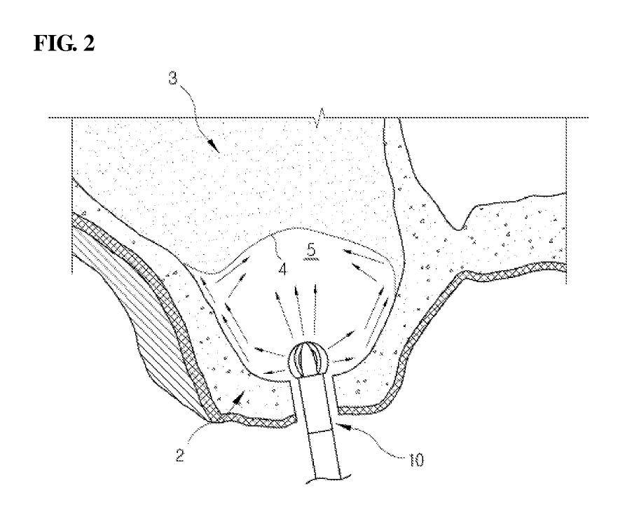

FIG. 1 shows a region where the fixture of an implant will be placed and illustrates a case where sinus grafting is required because the residual ridge of an alveolar bone is too small, and FIG. 2 shows a state when a filling space for bone grafting is formed by lifting up a maxillary sinus membrane using a piezo insert for implant surgical operation in accordance with a first embodiment of the disclosure in FIG. 1.

When performing implant surgical placement, an implant, and more specifically the fixture of the implant is placed in the direction of reference character “P.” As described before, the fixture is kept on standby for a certain amount of time so as to osseointegrate into a surrounding bone after the fixture of the implant is placed. If osseointegration is achieved as desired, an abutment is fitted into the fixture, followed by covering the abutment with a final prosthetic device to complete the implant surgical procedure.

A series of processes of implant surgical operation as described above can apply to a general case, in other words when there is sufficient alveolar bone 2 in the region 1 where the fixture of an implant will be placed. In this case, the implant surgical operation can be performed in the order listed according to the above method without any additional measures.

However, when the alveolar bone 2 in the region 1 where the fixture of an implant will be placed is insufficient as shown in FIG. 1, or in case there exist only thin (narrow, or shallow) residual ridge as indicated by A in FIG. 1, first the maxillary sinus membrane 4 of a maxillary sinus 3 is lifted up (raised up) as shown in FIG. 2 to secure a filling space 5 for bone grafting. Thereafter, the bone grafting is performed in this filling space 5 to build a foundation into which the fixture of an implant is to be placed, followed by the above described implant surgical operation.

For reference, a maxillary sinus 3 denotes an empty space inside the cheekbone as noted, and the maxillary sinus membrane 4 refers to a thin membrane attached to the inner face of the maxillary sinus 3.

Indeed, a series of processes of implant surgical operation described above are a method performed generally in prior art too. In order to secure a filling space 5 for bone grafting by lifting up the maxillary sinus membrane 4 as shown in FIG. 2, it is necessary to operate in the OSC technique which is a crestal approach using a piezo insert 10 for implant surgical operation as will be described later. However, in case a conventional piezo insert for implant surgical operation (not shown) is used for such technique, there are problems occurred such as a case where a maxillary sinus membrane 4 is punctured by inadvertent force on the membrane 4 when excessive force is exerted in order to cut out the bone near the maxillary sinus membrane 4 or when a residual ridge is incorrectly measured or there exists an error different from the numerical value seen on radiology in the process of cutting into the residual ridge in order to reach the maxillary sinus membrane 4, a case where the maxillary sinus membrane 4 adheres to a floor underneath the maxillary sinus 3 too tightly to separate even after all the bones near the maxillary sinus 3 have been cut out while maintaining the safety of the maxillary sinus membrane 4, and a case where the maxillary sinus membrane is punctured by vertical upward force, which exceeds the tension of the membrane, exerted on a septum that exists anatomically inside the maxillary sinus 3, because of the structural limitations of the piezo insert.

Accordingly, the disclosure proposes a piezo insert 10 for implant surgical operation that makes it easy to form a vertical hole or to expand the hole in the residual ridge of the maxillary sinus 3, thereby facilitating the filling of a bone graft material therein later, and that further increases the rate of success of resulting implant surgical operation as compared with prior art, while solving the above-mentioned problems.

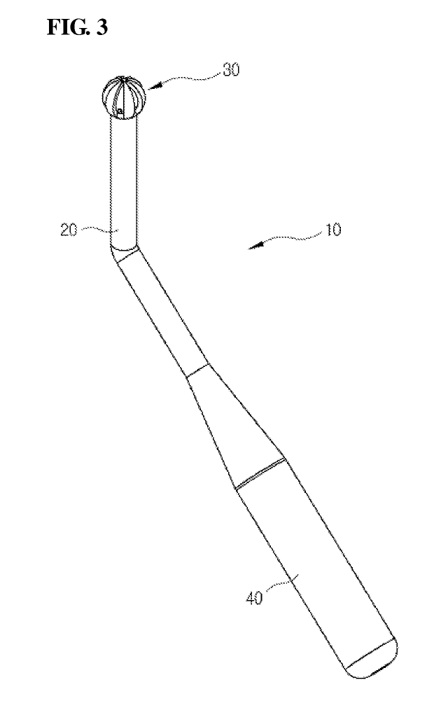

The detailed description of a first embodiment of such piezo insert 10 for implant surgical operation is provided as below, by referring to FIGS. 3 to 6.

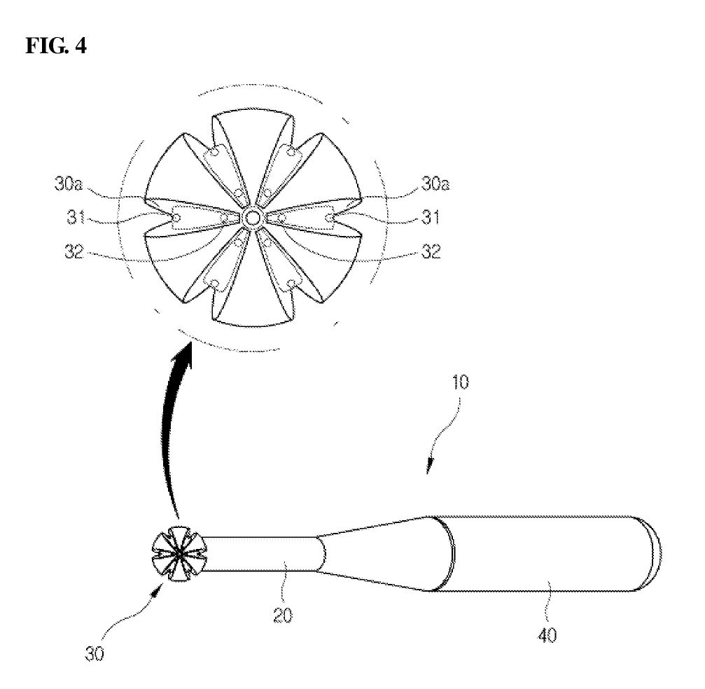

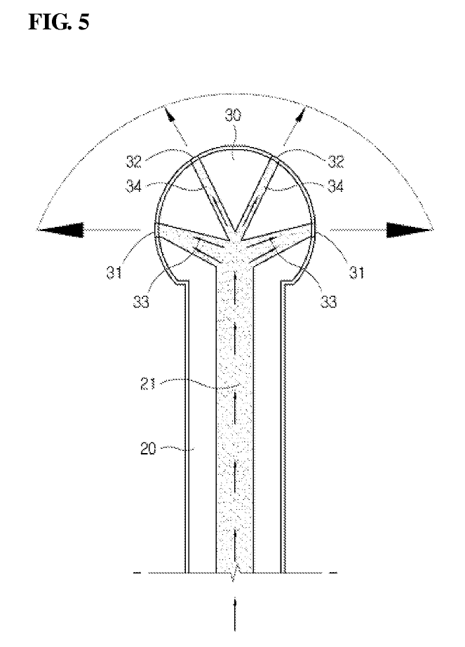

FIG. 3 is a perspective view of the piezo insert for implant surgical operation in accordance with the first embodiment of the disclosure shown in FIG. 2, FIG. 4 is a plan view of FIG. 3, and FIG. 5 is a schematic sectional view of a part of an insert tip of FIG. 3.

As shown in these drawings, the piezo insert 10 for implant surgical operation of the present embodiment generally comprises an insert pole 20, an insert tip 30 and an insert body 40.

The insert pole 20 denotes the part other than the insert tip 30 and the insert body 40, and is formed with a thin tubular body.

As shown, the insert pole 20 has a bent structure to allow easy access to a maxillary sinus 3 as shown in FIGS. 1 and 2. The bent structure may comprise a fully “L” shaped bent structure or a slightly bent structure.

The present embodiment uses the latter structure. As a matter of fact, since the scope of the disclosure is not limited to such structure, the insert pole 20 may comprise a structure of a straight rod.

As shown in FIG. 5, the inside of the insert pole 20 is formed with a water supply passage 21 for supplying water to lift up the maxillary sinus membrane 4.

Before describing the insert tip 30, the insert body 40 will be described first. The insert body 40 is a part connected to the insert pole 20 and can be used as a handle.

In other words, the insert body 40 may be a part to be grasped by a surgical operator in order to lift up the maxillary sinus membrane 4. However, since the operator may perform surgical operation by holding the rear end of the above described insert pole 20, the insert body 40 needs not necessarily to be provided.

Nonetheless, if the insert body 40 is provided as in the present embodiment, there may be a benefit of enhancing convenience to an operator. If the insert body 40 is provided as in the embodiment, it is desirable to make the insert body 40 larger than the insert pole 20 in volume to provide easy grasping thereof. In addition, there may be further provided means for preventing slippage on a side of the insert body 40. The means for preventing slippage may be in the form of a pad, or in the form of grooves.

For reference, since the piezo insert 10 for implant surgical operation serves for lifting up the maxillary sinus membrane 4 by squirting water while cutting a bone, it requires a certain type of a power supply.

A power supply may be provided in the insert body 40 in a rechargeable manner, or may be provided through connection to a hand piece (not shown) of a piezo main device whose patent application was filed by the present applicant.

The latter may be a general way in the disclosure. In this case, it may be advantageous to apply a method of receiving electrical vibration generated from the piezo main device to convert into mechanical vibration.

Next, the insert tip 30 is a part actually used to lift up the maxillary sinus membrane 40 as shown in FIG. 2.

The insert tip 30 comprises a plurality of water squirt holes 31, 32 formed along a circumferential direction at an end of the insert pole 20, and a plurality of connecting passages 33, 34 for connecting the water supply passage 21 with corresponding one of the plurality of water squirt holes 31, 32.

As described previously, the insert tip 30 is the part that actually lifts up the maxillary sinus membrane 40 as shown in FIG. 2. This insert tip 30 has an outer face that forms a cut face 30a for cutting a bone, and has a spherical shape that a part of the insert tip 30 connected to the insert pole 20 is partially cut out.

Since the shape of the insert tip 30 is not limited to a spherical shape, an elliptical shape or the like similar to a spherical shape can also be used as the shapes of the insert tip 30. In addition, though the insert tip 30 is shown in the form of a flower bud in the drawings of the disclosure, the insert tip 30 may be manufacture in various shapes departing from the shape shown in the drawings as long as it can squirt water in the manner described below. In other words, the scope of the insert tip 30 of the disclosure is not necessarily limited to the shape shown in the drawings.

Here, the outer face of the insert tip 30 forms a cut face 30a for cutting a bone, and the cut face 30a in this case just refers to a face having a sharp leading edge and is not limited to the shape shown in the drawings.

That is, the cut face 30a formed on the outer face of the insert tip 30 may be manufactured in various shapes other than the ones shown in the drawings. The present disclosure simply shows a cut face 30a manufactured in a partially cut-out form along the circumferential direction of the insert tip 30.

Such a structure is just an embodiment of the insert tip 30. For instance, if a dental implant drill is used to bore a hole, there is no need to form a cut face 30a on the outer face of the insert tip 30. In this case, the insert tip 30 will be good enough with a rounded shape only, and water squirt holes 31, 32 at appropriate positions on the outer face.

Next, the water squirt holes 31, 32 and connecting passages 33, 34 formed in the insert tip 30 will be described. First, the insert tip 30 of the present embodiment is provided with a plurality of water squirt holes 31, 32.

Though there are cases where only one central water squirt hole (not shown) is provided in prior art, if a plurality of water squirt holes 31, 32 are provided as in the present embodiment, there is an advantage of reducing the concentration of pressure, which is applied to the maxillary sinus membrane 4, on one side.

The plurality of water squirt holes 31, 32 comprises a plurality of lateral water squirt holes 31 formed along a circumferential direction of a middle part or a lower part of the insert tip 30 for squirting water laterally, and a plurality of upward water squirt holes 32 formed along a circumferential direction of an upper part of the insert tip 30 for squirting water upward.

With reference to FIG. 4, though six lateral water squirt holes 31 and six upward water squirt holes 32 are provided along a circumferential direction of the insert tip 30 in the present embodiment, the number of water holes does not limit the scope of the disclosure. In particular, the upward water squirt holes 32 may not need as many as six. Six upward waster squirt holes are provided for the convenience of illustration in the embodiment.

In order to more smoothly lift up the maxillary sinus membrane 4, or in order for the water pressure exerted on the maxillary sinus membrane 4 to be uniform, it is desirable for the lateral water squirt holes 31 and the upward water squirt holes 32 to have a regular arrangement with respect to each other along a circumferential direction of the insert tip 30.

If such an arrangement is applied, the water spray on the whole exerts uniform pressure on the maxillary sinus membrane 4, or provides uniform pressure as indicated by dotted arc in FIG. 5. Accordingly, it establishes a form that truly satisfies Pascal's principle so that the force exerted on the membrane per unit area can be minimized, and in particular, it is possible to easily separate the membrane from the interior border of the maxillary sinus 3 with the pressure of water squirted laterally from the lateral water squirt holes 31.

Though it can be said that the upward streams of water from the upward water squirt holes 32 are more for preventing the insert tip 30 from directly touching the maxillary sinus membrane 4 than for lifting up the maxillary sinus membrane 4 that is not always the case.

Furthermore, in forming the lateral water squirt holes 31 and upward water squirt holes 32 in the insert tip 30 of spherical shape or elliptical shape, it is advantageous to design a virtual water squirt angle connecting the lateral water squirt holes 31 and the upward water squirt holes 32 to be less than or equal to 90°.

This is the result obtained through repetitive experiments, and has an advantage that it can apply to various shapes of interior border of the maxillary sinus 3 which are as different as its patients by designing the water squirt holes such that water streams make various angles less than or equal to 90°.

Next, the plurality of connecting passages 33, 34 comprises a plurality of lateral connecting passages 33 for interconnecting the plurality of lateral water squirt holes 31 and the water supply passage 21, and a plurality of upward connecting passages 34 for interconnecting the plurality of upward water squirt holes 32 and the water supply passage 21.

In forming the plurality of lateral connecting passages 33 and the plurality of upward connecting passages 34 as described above, the water flow space of the lateral connecting passages 33 is formed larger than the water flow space of the upward connecting passages 34 in the embodiment as shown in FIG. 5. However, since the scope of the disclosure is not limited to such construction, it may also be possible to form the water flow space of the lateral connecting passages 33 to be substantially equal to the water flow space of the upward connecting passages 34.

In addition, the lateral connecting passages 33, in particular, may be formed such that the cross-sectional area thereof is gradually getting smaller or is gradually getting larger from the water supply passage 21 side toward the lateral water squirt holes 31 side.

Such a structure is for adjusting the amount and direction of water when the water is squirted from the plurality of lateral water squirt holes 31 and the plurality of upward water squirt holes 32 after passing through the plurality of lateral connecting passages 33 and the plurality of upward connecting passages 34 from the water supply passage 21.

In order for the water to be squirted to flow relatively less in upward direction and relatively more in lateral direction, the lateral connecting passages 33 are formed larger than the upward connecting passages 34 in this embodiment. Furthermore, in order to increase the water inlet area, the cross-section of the inlet is formed at an angle. On the contrary, the upward connecting passages 34 have smaller diameter relative to the lateral connecting passages 33, and are disposed in the direction of water flow so that the water may not stagnate.

In FIG. 5, the lateral connecting passages 33 are shown such that the cross-sectional area thereof is gradually getting smaller from the water supply passage 21 side toward the lateral water squirt holes 31 side. In this case, there is an advantage of increasing the pressure or velocity of the water squirted from the lateral water squirt holes 31. Thus, it is possible to adjust the velocity or intensity of squirting water by appropriately modifying the shape of the lateral connecting passages 33.

For the upward connecting passages 34, it is possible to change the shape of streams of squirting water into various forms by modifying the shape of the outlet of the upward connecting passages 34, unlike the one shown in FIG. 5. In addition, it is possible to prevent the concentration of water pressure on a part of the maxillary sinus membrane 4 by providing a plurality of upward connecting passages 34 as in the embodiment.

Furthermore, the end parts of the plurality of connecting passages 33, 34 that abut on the water supply passage 21 are formed such that the end parts are inclined with respect to the water supply passage 21.

Such a structure provides a larger area that meets the water flowing from the water supply passage 21, thereby enabling the water to flow easily through the lateral connecting passages 33 in lateral direction. In addition, by disposing the inlet ends of the plurality of upward connecting passages 34 at a location higher than that of the inlet ends of the plurality of lateral connecting passages 33 at a non-horizontal position, it is possible to adjust the amount of the water flowing toward the upward connecting passages 34 to be less. However, since the scope of the disclosure is not limited to this, the end parts of the plurality of connecting passages 33, 34 that abut on the water supply passage 21 may also be provided in one of the states where the end parts are parallel to, or intersect the water supply passage 21.

With such construction, if the piezo insert 10 for implant surgical operation of the embodiment is disposed and activated as shown in FIG. 2 under the condition of the maxillary sinus 3 as shown in FIG. 1, it is possible to easily lift up the maxillary sinus membrane 4 by an organic mechanism of cutting and water squirting.

In particular, as the water squirt method is implemented differently from prior art methods, it is possible to solve various problems such as a case of puncturing a maxillary sinus membrane 4, a case where the maxillary sinus membrane 4 adheres to a floor underneath the maxillary sinus 3 too tightly to separate, and a case where the membrane is punctured by vertical upward force, which exceeds the tension of the membrane, exerted on a septum that exists anatomically inside the maxillary sinus 3, to make it easy to form a vertical hole or to expand the hole in the residual ridge of the maxillary sinus 3, thereby facilitating the filling of a bone graft material therein later, and to further increase the rate of success of resulting implant surgical operation as compared with prior art.

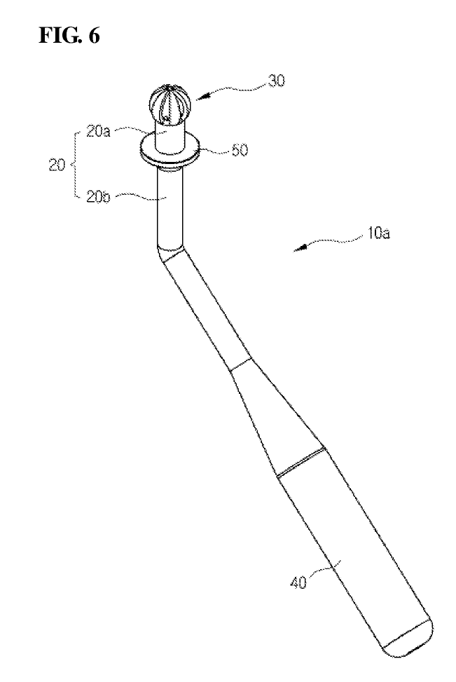

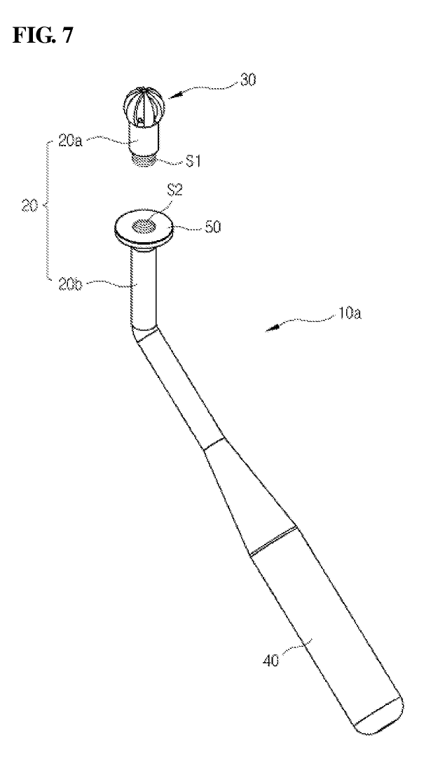

FIG. 6 is a perspective view of a piezo insert for implant surgical operation in accordance with a second embodiment of the disclosure, and FIG. 7 is an exploded perspective view of FIG. 6.

A piezo insert (not shown) for implant surgical operation is used to grind out a bone and to safely expose a maxillary sinus membrane 4 under a condition that even though there exists a little residual ridge, there is not enough residual ridge contrary to FIG. 1, and accordingly bone grafting is required. During such operation, often times the maxillary sinus membrane 4 gets punctured because of excessive force exerted on the insert tip 30. Such an incident inevitably occurs from time to time no matter how skilled an operator is.

Accordingly, since it is not appropriate to rely on the operator's experience only, the piezo insert 10a for implant surgical operation is further provided with a stopper 50 in the present embodiment as shown in FIGS. 6 and 7.

That is, in the piezo insert 10a for implant surgical operation of the embodiment, a stopper 50 is further provided on the insert pole 20, for limiting an excessive insertion depth of the insert tip 30 that cuts toward and is inserted into an alveolar bone 2 (see FIGS. 1 and 2).

The position of the stopper 50 may be adjusted appropriately, and if such a stopper 50 is provided, it is possible to limit an excessive insertion depth of the insert tip 30 because the stopper 50 hits and is held by the exterior border of the alveolar bone 2 even when inappropriate force is applied to the insert tip 30. Thus, it is possible to prevent the puncture of the maxillary sinus membrane 4 by the excessive pressure of the insert tip 30.

Therefore, it is possible to prevent unintentional excessive force on the maxillary sinus membrane by limiting an excessive insertion depth of the insert tip that cuts toward and is inserted into an alveolar bone by providing such a stopper, and to secure completely safe surgical operation using stoppers of various lengths.

In this embodiment, the insert pole 20 is divided into a working part 20a having the insert tip 30 formed at an end thereof, and a holding part 20b which is separated from the working part 20a, unlike the previous embodiment. In this case, the stopper 50 is provided on an end of the holding part 20b such that the stopper 50 is longer than the rest of the holding part 20b in radial direction, to serve as described above.

The two divided working part 20a and holding part 20b may be attached to or detached from each other as shown in FIGS. 6 and 7, and a screw connection method is used as an attachment method between the working part 20a and the holding part 20b as shown in FIG. 7.

By forming a male thread S1 on one of the working part 20a and the holding part 20b and a female thread S2 on the other, and tightening the two parts through these threads, an assembly shown in FIG. 6 can be easily achieved.

For reference, though the working part 20a is formed with the male thread S1 and the holding part 20b with the female thread S2 in this embodiment, it is also possible to form the threads in the other way.

In particular, by separately manufacturing the working part 20a and the holding part 20b of the insert pole 20 and screw connecting them as in the embodiment, it is possible to select the working part 20a having an appropriate length after measuring the size A in FIG. 1 in advance, and to connect the working part 20a to the holding part 20b. Accordingly, there is an advantage that the implant surgical operation can be easily performed without any damage to the maxillary sinus membrane 4 even by an operator with less experience.

However, since the scope of the disclosure is not limited to this, the attachment method between the working part 20a and the holding part 20b may also be either a hook combination method or a press fit method, other than the common screw connection method. Depending on the cases, the working part 20a and the holding part 20b may be manufactured integrally. Integral manufacturing can also be used, as long as the stopper 50 is formed thereon.

Those skilled in the art will understand that various modifications and other equivalent embodiments thereof can be contemplated. Therefore, it should be understand that the invention is not limited to the specific embodiments as described above. Therefore, the true technical scope of the invention should be defined by the technical spirit specified in the accompanying claims. It should be understood that the invention is intended to cover all modifications, equivalents and substitutes thereof within the spirit and scope of the invention as defined in the accompanying claims.

What is claimed is:

1. A piezo insert for implant surgical operation comprising:
an insert pole having a water supply passage formed therein for supplying water to lift up a maxillary sinus membrane; and
an insert tip comprising:
a plurality of water squirt holes provided along a circumferential direction of the insert pole at one end thereof, and
a plurality of connecting passages for connecting the plurality of water squirt holes and the water supply passage.

2. The piezo insert of claim 1, wherein the insert tip has an outer face that forms a cut face for cutting a bone, and has an elliptical shape or a spherical shape that a part of the insert tip connected to the insert pole is partially cut out.

3. The piezo insert of claim 2, wherein the plurality of water squirt holes comprises:
a plurality of lateral water squirt holes formed along a circumferential direction of a middle part or a lower part of the insert tip for squirting water laterally, and
at least one upward water squirt hole formed along a circumferential direction of an upper part of the insert tip for squirting water upward.

4. The piezo insert of claim 3, wherein the at least one upward water squirt hole comprises a plurality of upward water squirt holes, and
the plurality of lateral water squirt holes and the plurality of upward water squirt holes have a regular arrangement with respect to each other along a circumferential direction of the insert tip.

5. The piezo insert of claim 3, wherein a virtual water squirt angle connecting one of the lateral water squirt holes and one of the upward water squirt holes is less than or equal to 90°.

6. The piezo insert of claim 3, wherein the plurality of connecting passages comprises:
a plurality of lateral connecting passages for interconnecting the plurality of lateral water squirt holes and the water supply passage, and
a plurality of upward connecting passages for interconnecting the plurality of upward water squirt holes and the water supply passage, and
wherein each water flow space of the lateral connecting passages is substantially equal to each water flow space of the upward connecting passages, or the water flow space of the lateral connecting passages is formed larger than the water flow space of the upward connecting passages.

7. The piezo insert of claim 6, wherein the lateral connecting passages are formed such that a cross-sectional area thereof is gradually getting smaller or is gradually getting larger from the water supply passage side toward the lateral water squirt holes side.

8. The piezo insert of claim 6, wherein end parts of the plurality of connecting passages that abut on the water supply passage are provided in one of the states where the end parts are parallel to, are inclined with respect to, or intersect the water supply passage.

9. The piezo insert of claim 6, wherein inlet ends of the plurality of upward connecting passages are disposed at a location higher than the location of inlet ends of the plurality of lateral connecting passages at a non-horizontal position.

10. The piezo insert of claim 1, further comprising an insert body for a handle connected to the insert pole.

11. The piezo insert of claim 1, further comprising a stopper provided on the insert pole, for limiting an excessive insertion depth of the insert tip that cuts toward and is inserted into an alveolar bone.

12. The piezo insert of claim 11, wherein the insert pole comprises:
a working part having the insert tip formed at an end thereof, and
a holding part, and
wherein the stopper is provided on an end of the holding part such that the stopper is longer than the rest of the holding part in radial direction.

13. The piezo insert of claim 12, wherein the working part and the holding part of the insert pole are attachable to and detachable from each other.

14. The piezo insert of claim 13, wherein an attachment method between the working part and the holding part of the insert pole is a method selected from a screw connection method, a hook combination method and a press fit method.

15. The piezo insert of claim 12, wherein the working part and the holding part of the insert pole are integrally formed.
